(19) United States
(12) Patent Application Publication
(10) Pub. No.: US 2005/0128223 A1
(43) Pub. Date: Jun. 16, 2005

(54) Method and system for generating pixel gray scale levels

(76) Inventors: Adam Ghozeil, Corvallis, OR (US); Eric Martin, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/734,685

(22) Filed: Dec. 12, 2003

(51) Int. Cl. G09G 3/36

(52) U.S. Cl. 345/690

(57) ABSTRACT

A method of generating 2^{m} gray scale levels for a number of rows of pixels to be displayed during a video frame, where m is an integer greater than or equal to zero. The method includes dividing the frame into 2^{m}-1 time slices, updating each of the rows of pixels during m time slices, and distributing the row updates among the time slices such that a substantially equal number of the rows of pixels are updated during each of the time slices.

### BACKGROUND

A conventional system or device for displaying an image, such as a display, projector, or other imaging system, is frequently used to display a still or video image. Viewers evaluate display systems based on many criteria such as image size, contrast ratio, color purity, brightness, pixel color accuracy, and resolution. Brightness and pixel color accuracy are particularly important metrics in many display markets because the brightness and pixel color accuracy can limit the size of a displayed image and control how well the image can be seen in venues having high levels of ambient light.

Many factors affect the brightness of an image produced by a display system. One of the major factors is the type of spatial light modulator (SLM) that is used to modulate the light used to produce the image. The brightness, clarity, and accuracy of an image produced by a display system vary proportionally with the number of gray scale levels that the display system's modulator produces. Thus, it is often desirable for a display system to use a modulator that is capable of producing many levels of gray scale intensities.

Varying levels of gray scale in a modulator may be achieved by turning individual pixels on and off quickly within a given video frame. To achieve m bits of gray scale, or 2^{m} gray levels, a pixel must be able to turn on and back off in 1/(2^{m})th of a frame. It follows that the update data required to activate the pixel and the update data required to deactivate the pixel must be sent within 1/(2^{m})th of a frame of each other. Thus, some display systems update every pixel every 1/(2^{m})th of a frame in order to provide 2^{m} levels of gray scale. This peak update data rate may be very fast in display systems configured to generate a high number of gray scale levels. High peak update data rates often require complex and costly interface electronics to send the update data to the modulator.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 illustrates an exemplary display system according to one exemplary embodiment.

FIG. 2 illustrates an exemplary spatial light modulator according to one exemplary embodiment.

FIG. 3 illustrates a spectrum of exemplary gray scale levels according to one exemplary embodiment.

FIG. 4 illustrates an exemplary video frame that has been divided into fifteen time slices according to one exemplary embodiment.

FIG. 5 illustrates that the particular gray scale level of a pixel during a frame may linearly depend on the total number of time slices in the frame during which the pixel is in the “on” state according to one exemplary embodiment.

FIG. 6 illustrates an example wherein 2^{m} gray scale levels are generated for a pixel by updating the pixel only m times during the frame according to one exemplary embodiment.

FIG. 7 illustrates one of the alternative orders in which the m bits may be sent to the modulator to generate 2^{m} gray scale levels for a pixel according to one exemplary embodiment.

FIG. 8 is a flow chart illustrating an exemplary method of generating 2^{m} gray scale levels for a number of rows of pixels in a displayed image according to one exemplary embodiment.

FIG. 9 illustrates an exemplary update scheme for a number of rows of pixels according to one exemplary embodiment.

FIG. 10 illustrates an alternative exemplary update scheme for a number of rows of pixels according to one exemplary embodiment.

FIG. 11 illustrates an alternative exemplary update scheme for a number of rows of pixels according to one exemplary embodiment.

FIG. 12 illustrates an alternative exemplary update scheme for a number of rows of pixels according to one exemplary embodiment.

FIG. 13 illustrates an alternative exemplary update scheme for a number of rows of pixels according to one exemplary embodiment.

FIG. 14 illustrates an alternative exemplary update scheme for a number of rows of pixels according to one exemplary embodiment.

Throughout the drawings, identical reference numbers designate similar, but not necessarily identical, elements.

### DETAILED DESCRIPTION

The present specification describes a method of generating a number of gray scale levels for pixels in a displayed image with a spatial light modulator (SLM). The method reduces the peak update data rate traditionally required to generate the gray scale levels using an SLM. In the following description, for purposes of explanation, numerous specific details are set forth in order to provide a thorough understanding of the present display system. It will be apparent, however, to one skilled in the art that the present display system may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

The term “display system” will be used herein and in the appended claims, unless otherwise specifically denoted, to refer to a projector, projection system, image display system, television system, video monitor, computer monitor system, or any other system configured to display an image. The image may be a still image, a series of images, or motion picture video. The term “image” will be used herein and in the appended claims, unless otherwise specifically denoted, to refer broadly to a still image, series of images, motion picture video, or anything else that is displayed by a display system.

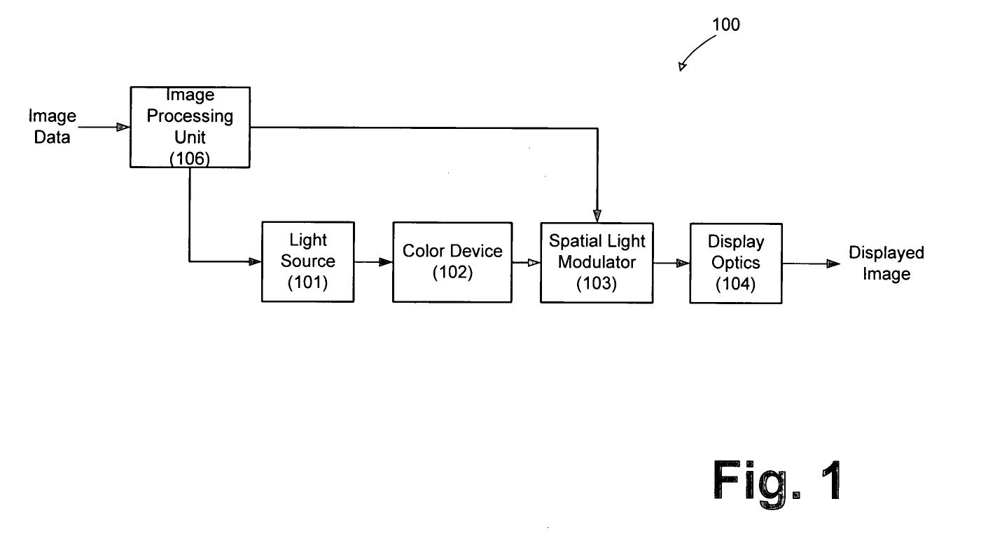

FIG. 1 illustrates an exemplary display system (100) according to an exemplary embodiment. The components of FIG. 1 are exemplary only and may be modified, changed, or added to as best serves a particular application. As shown in FIG. 1, image data is input into an image processing unit (106). The image data defines an image that is to be displayed by the display system (100). While one image is illustrated and described as being processed by the image processing unit (106), it will be understood by one skilled in the art that a plurality or series of images may be processed by the image processing unit (106). The image processing unit (106) performs various functions including controlling the illumination of a light source (101) and controlling a spatial light modulator (SLM) (103). The image processing unit (106) will be explained in more detail below.

As shown in FIG. 1, the light source (101) provides a beam of light to a color device (102). The light source (101) may be, but is not limited to, a high pressure mercury lamp. The color device (102) is optional and enables the display system (100) to display a color image. The color device (102) may be a sequential color device or a color device, for example. As will be explained below, the color device (102) may be integrated into the spatial light modulator (103) according to an exemplary embodiment.

Light transmitted by the color device (102) is focused onto the spatial light modulator (SLM) (103) through a lens or through some other device (not shown). An SLM is a device that modulates incident light in a spatial pattern corresponding to an electrical or optical input. The terms “SLM” and “modulator” will be used interchangeably herein to refer to a spatial light modulator. The incident light may be modulated in its phase, intensity, polarization, direction, wavelength, color, hue, or any other property inherent to light by the modulator (103). Thus, the SLM (103) of FIG. 1 modulates the light output by the color device (102) based on input from the image processing unit (106) to form an image bearing beam of light that is eventually displayed or cast by display optics (105) on a viewing surface (not shown). The display optics (105) may comprise any device configured to display or project an image. For example, the display optics (105) may be, but are not limited to, a lens configured to project and focus an image onto a viewing surface. The viewing surface may be, but is not limited to, a screen, television, wall, liquid crystal display (LCD), or computer monitor.

The SLM (103) may be, but is not limited to, a liquid crystal on silicon (LCOS) array, a micromirror array, or a diffractive light device (DLD). LCOS and micromirror arrays are known in the art and will not be explained in detail in the present specification. An exemplary, but not exclusive, LCOS array is the Philips™ LCOS modulator. An exemplary, but not exclusive, micromirror array is the Digital Light Processing (DLP) chip available from Texas Instruments™ Inc.

As mentioned, the SLM (103) may also be a DLD in one exemplary embodiment. The DLD may be a microelectromechanical system (MEMS) arrangement that integrates the color device (102) and the SLM (103) into one device. The DLD may comprise a variable capacitor composed of a fixed reflective ground plate and a semi-transparent, (electrostatically) movable second plate. The variable gap between the plates may be used to produce interference or diffraction of light passing thereinto, and may be used for spatial light modulation in high resolution displays.

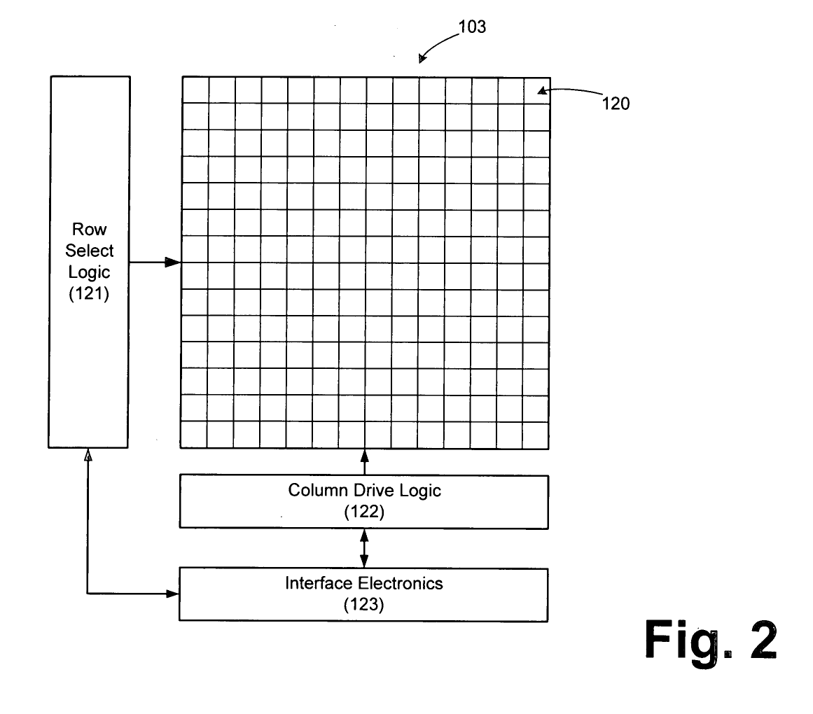

An exemplary SLM (103) is illustrated in FIG. 2. The exemplary SLM (103) of FIG. 2 comprises an array of micromirrors (120) for illustrative purposes. The array of micromirrors (120) comprises a number of rows of micromirrors (120). Each micromirror (120) corresponds to a pixel in the image that is to be displayed. The micromirrors (120) may be operated in a digital, or bistable, manner. Digital operation fully deflects a given micromirror to either a first position or a second position. The first position is the “on” position and the second position is the “off” position. The light source (102; FIG. 1) illuminates the entire array of micromirrors. Micromirrors deflected to the first position reflect light along a first path, whereas micromirrors deflected to a second position reflect light along a second path. The display optics (104) of the display system collect the light from the mirrors in the first or “on” position and focus the light onto an image plane. The light reflected by mirrors in the second or “off” position is prevented from reaching the image plane. A pixel associated with a micromirror in the “on” position is illuminated, whereas a pixel associated with a micromirror in the “off” position is not illuminated.

FIG. 2 illustrates control circuitry (121-123) that controls the operation of the micromirrors (120). For example, row select logic (121) and column drive logic (122) may send update data to particular micromirrors in the array of micromirrors (120) to indicate whether the micromirrors are to be in the “on” or “off” position at a given time. Interface electronics (123) may be included in the display system (100; FIG. 1) to interface between the other components of the display system (100; FIG. 1) and the logic (121, 122) controlling the SLM (103).

Pulse width modulation by the SLM (103) creates a number of levels of gray scale. In pulse width modulation, a given SLM element is rapidly turned on and off in response to update data sent to the element by the row select logic (121) and the column drive logic (122). As used herein and the appended claims, the term “SLM element” will be used to refer to a micromirror or other type of microdevice that is used by the SLM to define the gray scale level of a corresponding pixel. Furthermore, as used in herein and in the appended claims, unless otherwise specifically denoted, “update data” refers to data sent to a particular SLM element indicating to the element whether it is to be “on” or “off” during a particular time period.

The update data determines the level of gray scale for a particular SLM element's corresponding pixel, or, more specifically, whether the SLM element is in the “on” or “off” state in a particular time slice of the frame. Thus, it will be understood that any references to “updating a pixel” herein and in the appended claims, unless otherwise specifically denoted, refer to sending update data to the pixel's corresponding SLM element such that the pixel is characterized by the level of gray scale so indicated by the update data. Likewise, any references to “updating a row of pixels” herein and in the appended claims, unless otherwise specifically denoted, refer to sending update data for each of the pixels in a row of pixels to the pixels' corresponding SLM elements such that the pixels in the row are characterized by the level of gray scale so indicated by the update data. The update data will be described in more detail below.

Returning to FIG. 2, a micromirror's duty cycle, or amount of time that a given micromirror is in the “on” position in a given frame, determines the total amount of light contributed to the micromirror's corresponding pixel. If the pixel is pulsed quickly enough within a given frame, the human eye will accurately measure the gray scale level of the pixel during that frame, but will fail to detect the pulsing.

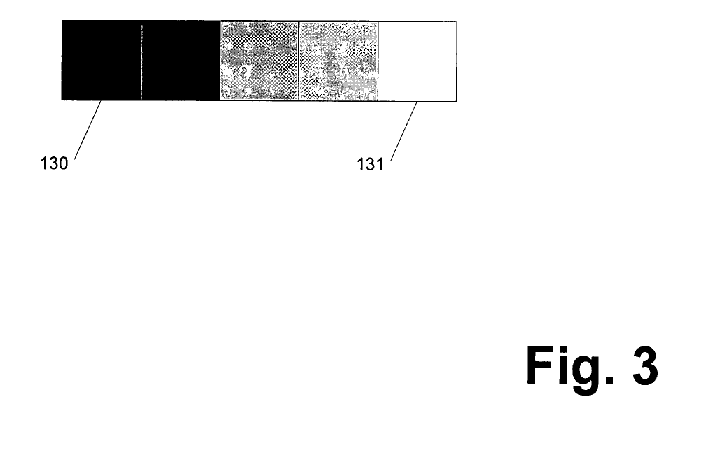

FIG. 3 illustrates a spectrum of exemplary gray scale levels according to an exemplary embodiment. The gray scale levels of FIG. 3 are illustrative and it will be recognized that there may be more or less levels of gray scale as best serves a particular display system. As shown in FIG. 3, the first gray scale level (130) is completely black. A completely black gray scale level corresponds to a pixel that is in the “off” state during an entire frame (i.e. the pixel's corresponding SLM micromirror or element is in the “off” position). As shown in FIG. 3, the gray scale levels increase in brightness until the last gray scale level (131). The last gray scale level (131) is white and corresponds to a pixel that is in the “on” state during an entire frame (i.e. the pixel's corresponding SLM micromirror or element is in the “on” position during the entire frame). The gray scale levels in between the first and last gray scale levels (130, 131) may be generated by varying the amount of time within a given frame that the pixel is “on.”

It is important to note that “gray scale” does not exclusively refer to a white-to-black spectrum. In an alternative embodiment, “gray scale” may refer to a spectrum between any two colors. For example, gray scale may refer to a red-to-black spectrum, green-to-black spectrum, blue-to-black spectrum, magenta-to-black spectrum, or any other color spectrum. Some modulators may also be configured to transition between colors that are not black or white. In these cases, update data to a pixel may configure the pixel to generate any one of multiple possible colors. Therefore, gray scale may also refer to a red-to-green spectrum, a green-to-blue spectrum, a blue-to-cyan spectrum, or any other transition between two colors. The exact gray scale spectrum will vary as best serves a particular application and may depend on the color output capability of the modulator.

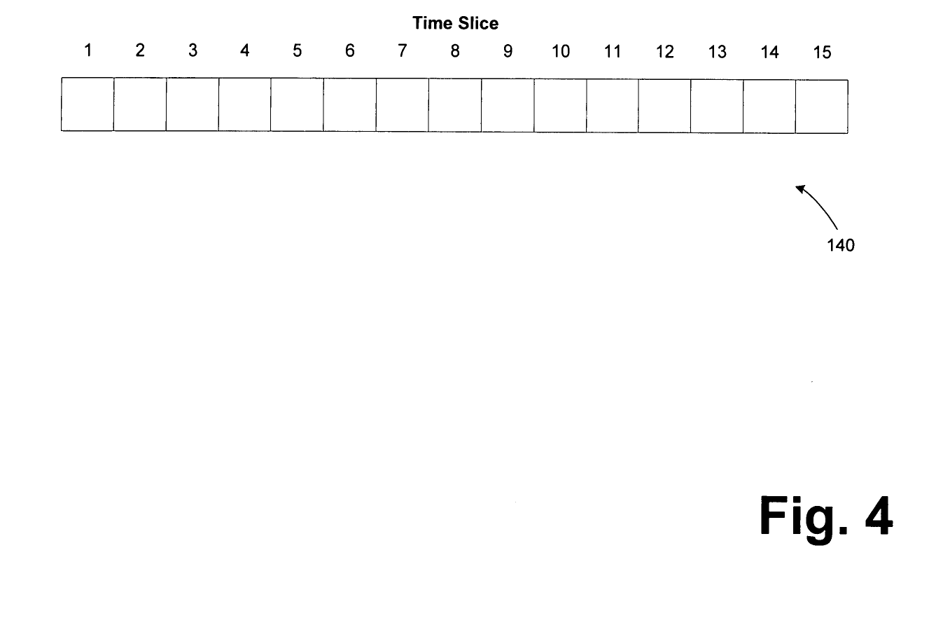

FIG. 4 illustrates an exemplary video frame (140) that has been divided into fifteen time slices. The frame (140) of FIG. 4 is illustrative and not limiting. For example, a frame may be divided into more or less time slices than fifteen. According to an exemplary embodiment, in a frame that has been divided into 2^{m}-1 time slices, a pixel may have 2^{m} possible gray scale levels. For example, a pixel may have sixteen possible gray scale levels in the exemplary frame (140) of FIG. 4 that has been divided into fifteen time slices. In terms of bits, a frame that has m bits of gray scale resolution is divided into 2^{m}-1 time slices and has 2^{m} gray scale levels. The variable “m,” as used herein and in the appended claims, may be any integer that is equal to or greater than zero. For example, the exemplary frame (140) of FIG. 4 has four bits of gray scale resolution.

The number of bits of gray scale resolution may vary as best serves a particular application. For example, some color display systems may be configured to generate 24-bit color, or eight bits of gray scale for each of three primary colors. Other display systems may be configured to generate more or less than three primary colors, each having more or less than eight bits of gray scale. Thus, an exemplary value for m may be 24. However, as previously explained, the value of m may vary as best serves a particular application.

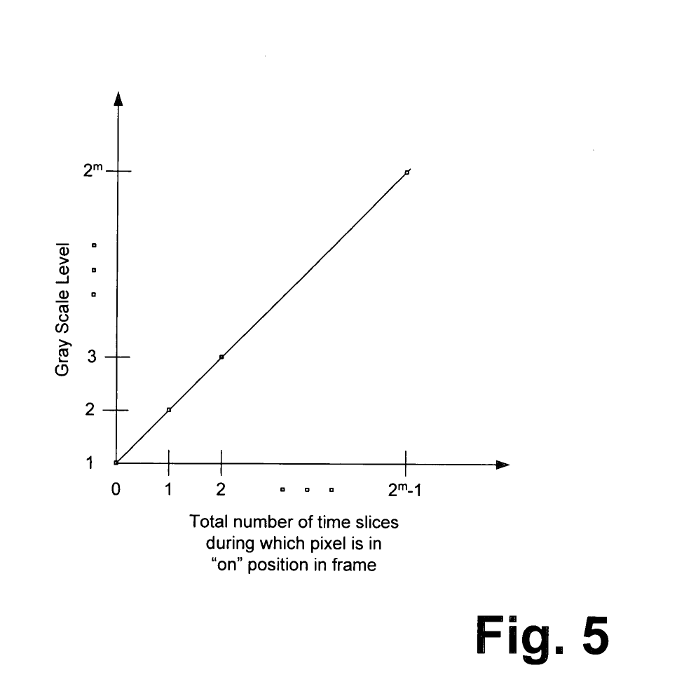

FIG. 5 illustrates that the particular gray scale level of a pixel during a frame may linearly depend on the total number of time slices in the frame during which the pixel is in the “on” state. FIG. 5 shows that there are 2^{m} possible gray scale levels in a frame that has 2^{m}-1 time slices. For illustrative purposes, the gray scale levels in the graph of FIG. 5 are labeled 1, 2, 3, . . . , 2^{m} with a gray scale level of 1 being the lowest (darkest) gray scale level and a gray scale level of 2^{m} being the highest (brightest) gray scale level. Thus, referring to FIG. 5, if a pixel is in the “on” state for none of the time slices in the frame, it has a gray scale level of 1. Likewise, if a pixel is in the “on” state for a total of one time slice, it has a gray scale level of 2. If a pixel is in the “on” position for a total of two time slices, it has a gray scale level of 3. Finally, as shown in FIG. 5, if a pixel is in the “on” state during all 2^{m}-1 time slices of a frame, it has a gray scale level of 2^{m}.

It is important to note that the gray scale level of a particular pixel depends on the total number of time slices in a frame during which the pixel is in the “on” state. Thus, according to an exemplary embodiment, the pixel may be “on” during any combination of time slices in a frame to achieve a particular gray scale level. For example, using the gray scale annotation of FIG. 5, a pixel may be “on” during any two of the time slices shown in FIG. 4 to achieve a gray scale level of 3. Referring to FIG. 4, the pixel may be on during time slices 1 and 2, 7 and 8, 15 and 1, or any other combination of two time slices within the frame (140; FIG. 4) to achieve a gray scale level of 3.

As mentioned, the gray scale level may be expressed in terms of bits. In general, 2^{m} gray scale levels are equal to m bits of gray scale. For example, sixteen gray scale levels equal four bits of gray scale. As will be recognized by one skilled in the art, an m-bit word includes a most significant bit (MSB) and a least significant bit (LSB). The MSB is the left-most bit in the m-bit word and the LSB is the right-most bit in the m-bit word. For illustrative purposes, the m bits will be represented herein and in the appended claims, unless otherwise specifically denoted, by the terms B₀, B₁, B₂, . . . , Bₘ₋₁, where B₀ is the LSB and Bₘ₋₁ is the MSB.

In one embodiment, each of the m bits may be update data in that they each define a pixel's state (i.e. whether the pixel is “on” or “off”) during one or more time slices of a frame. The LSB, or B₀, defines the pixel's state during one time slice of the frame and B₁ defines the pixel's state during two time slices of the frame. In general, Bₓ defines a pixel's state during 2^{x} time slices of a frame, where x is an integer and 0≦x≦m-1.

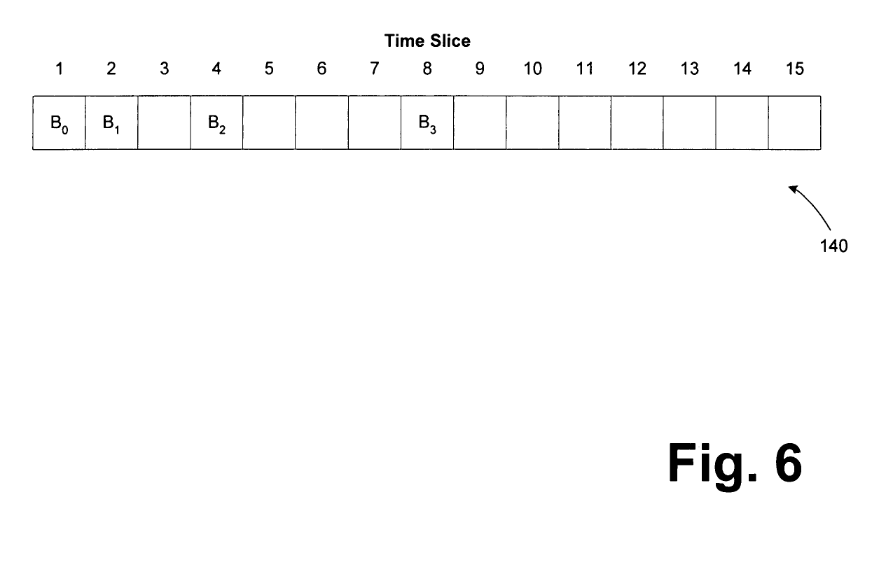

Because the gray scale level of a pixel during a frame can be defined using m bits, 2^{m} levels of gray scale may be generated for the pixel by sending update data to the SLM during only m of the 2^{m} time slices. FIG. 6 illustrates an example wherein 2^{m} gray scale levels are generated for a pixel by updating the pixel only m times during the frame. As shown in FIG. 6, the frame (140) is divided into fifteen time slices. Thus, there are sixteen gray scale levels and m=4.

As shown in FIG. 6, a pixel is updated four times during the frame (140) to achieve sixteen gray scale levels. The first bit, B₀, is sent to the SLM during time slice 1 and defines the pixel's state during one time slice. The second bit, B₁, is sent to the SLM during time slice 2 and defines the pixel's state during two consecutive time slices. The third bit, B₂, is sent to the SLM during time slice 4 and defines the pixel's state during four consecutive time slices. Finally, the fourth bit, B₃, is sent to the SLM during time slice 8 and defines the pixel's state during eight consecutive time slices.

Although FIG. 6 shows that update data bits are sent to the SLM to update the pixel, in an alternative embodiment, the update data may include alternative or additional data. In general, as will be used herein and in the appended claims, unless otherwise specifically denoted, “Bₓ” will refer to any and all update data defining a pixel's state during 2^{x} time slices of a frame, where x is an integer and 0≦x≦m-1.

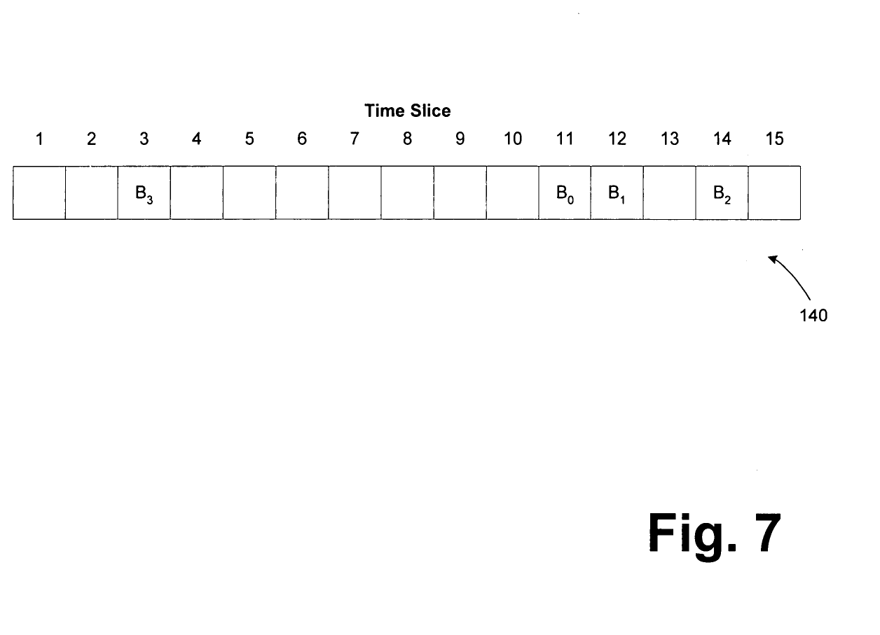

Any of the sixteen gray scale levels may be generated for the pixel by appropriately selecting which of the four update data bits is a “one” or a “zero.” Furthermore, because the gray scale level of a particular pixel depends on the total number of time slices in any order during which the pixel is in the “on” state during a frame, the order in which the m bits are sent to the modulator to update the pixel's gray scale level may vary. For example, FIG. 7 illustrates one of the alternative orders in which the m bits may be sent to the modulator to generate 2^{m} gray scale levels for the pixel. As shown in FIG. 7, B₃ may be sent during time slice 3, B₀ may be sent during time slice 11, B₁ may be sent during time slice 12, and B₂ may be sent during time slice 14.

As illustrated in FIG. 7, an update data bit may define a pixel's state during two groups of non-consecutive time slices through the use of image processing techniques known to one skilled in the art. For example, as shown in FIG. 7, B₂ may define a pixel's state during time slices 14-15 and time slices 1-2.

The exemplary update orders illustrated in FIGS. 6 and 7 are illustrative of the many possible orders in which m bits may be sent to the modulator to generate a particular gray scale level for a pixel. In general, any method of generating 2^{m} gray scale levels by updating a pixel m times during a frame as illustrated in FIGS. 6 and 7 will be referred to herein and in the appended claims, unless otherwise specifically denoted, as a “bit grouping method.” In one exemplary embodiment, all the pixels corresponding to a given row of SLM elements are updated at the same time using the same bit grouping method.

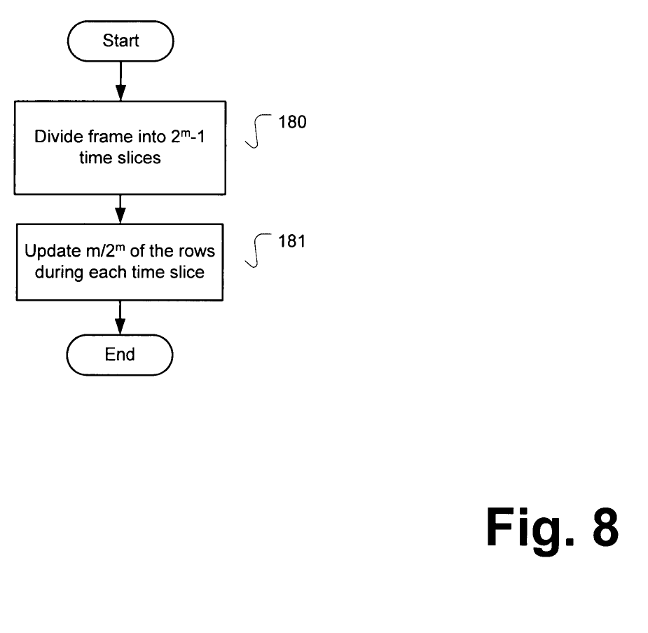

An exemplary method of generating 2^{m} gray scale levels for a number of rows of pixels in a displayed image will now be described using the flow chart of FIG. 8. As shown in FIG. 8, a frame is first divided into 2^{m}-1 time slices (step 180). According to one exemplary embodiment, each row of pixels is updated using a bit grouping method. In other words, each pixel in a row is updated during m time slices of every frame. However, according to one exemplary embodiment, the particular bit grouping method varies row by row. Thus, instead of updating each row of pixels during the same time slices in a frame, the update data for each row of pixels is sent during different time slices such that the total amount of update data sent per time slice is distributed approximately evenly among the total number of time slices within the frame. Thus, as shown in FIG. 8, update data for approximately m/2^{m} of the rows of pixels is sent to the SLM during each time slice (step 181). As will be shown below, by evenly dividing the number of rows that are updated among the time slices of a frame, the peak update data rate may be a fraction of the update data rate traditionally associated with generating 2^{m} gray scale levels for a number of rows of pixels.

As will be recognized by one skilled in the art, updating m/2^{m} of the rows during each time slice evenly distributes the number of rows that are updated among the time slices in the frame. In one embodiment, if m/2^{m} does not divide evenly into the total number of rows, the number of rows that are updated per time slices may be rounded up or down to the nearest integer.

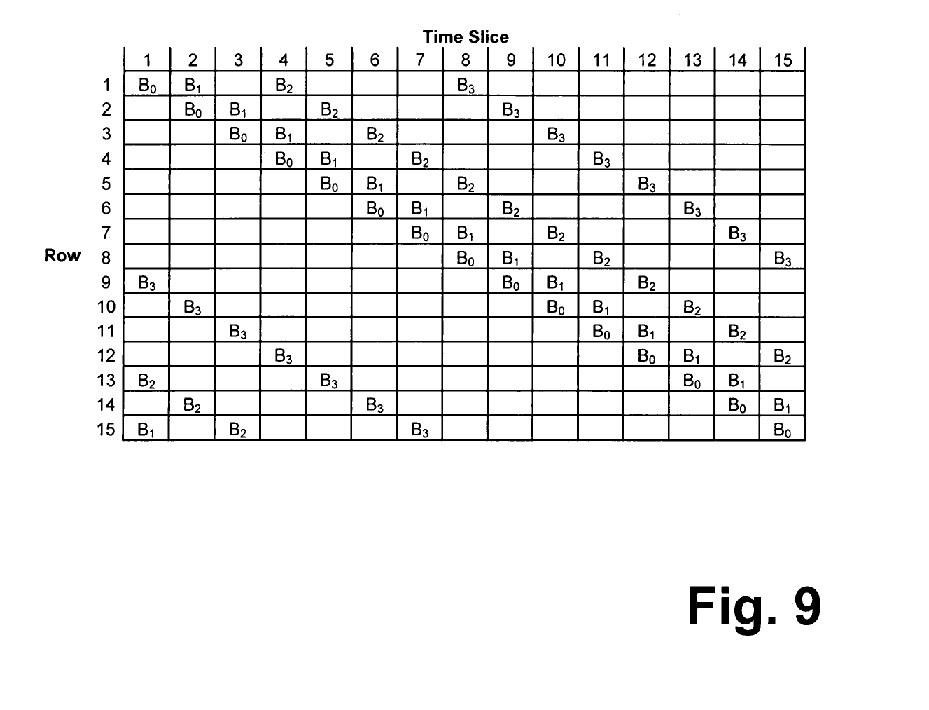

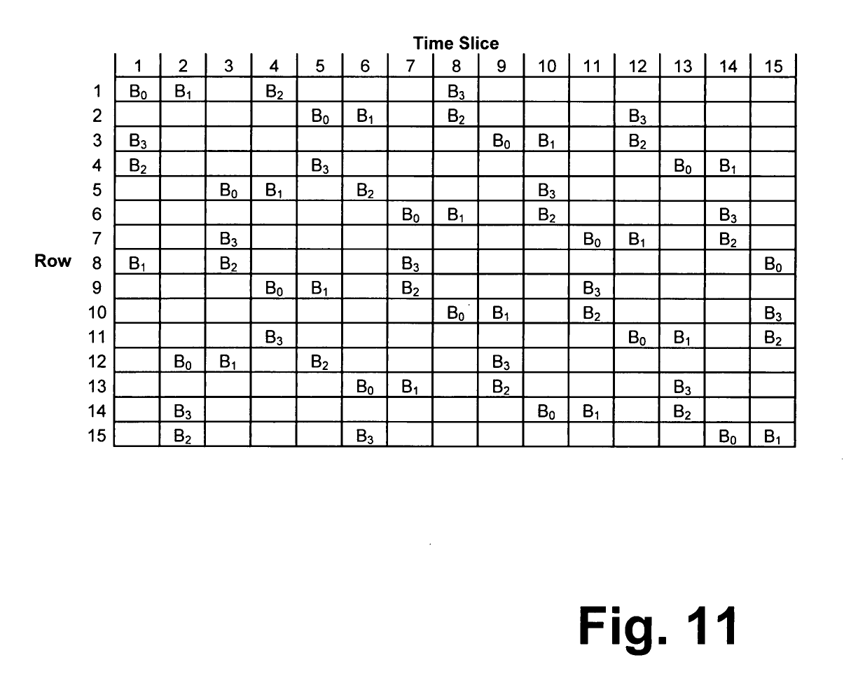

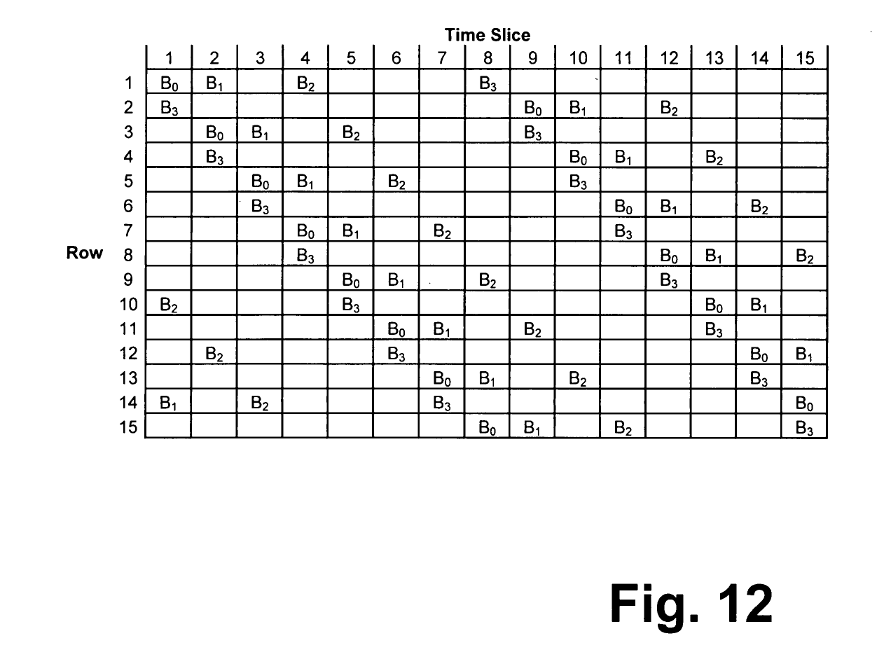

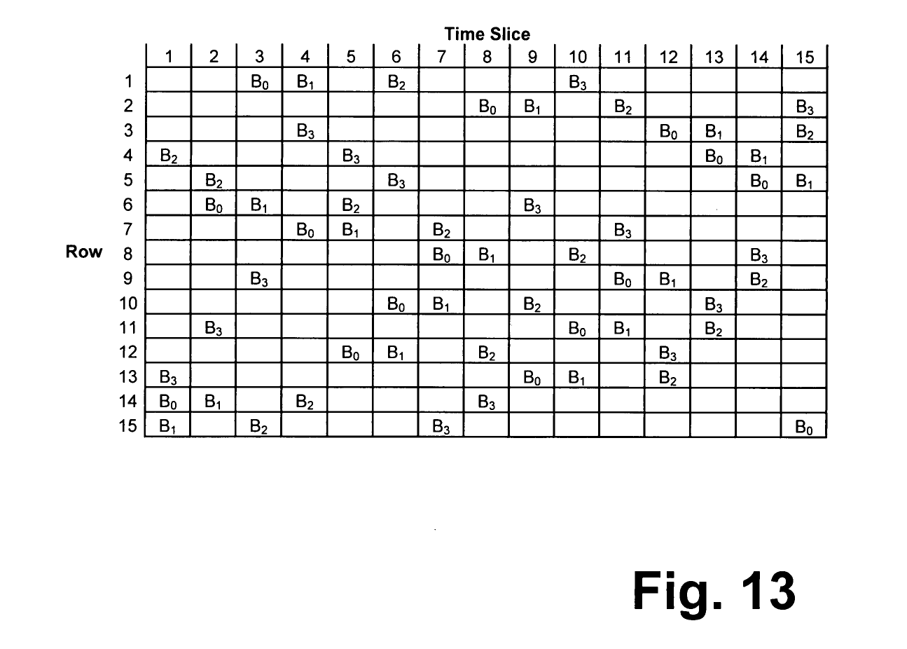

A number of examples wherein 2^{m} gray scale levels are generated for a number of rows of pixels using the method described in connection with FIG. 8 will now be given. The following examples described in connection with FIGS. 9-14 are illustrative of the many possible implementations of the presently described method of generating 2^{m} gray scale levels for a number of rows of pixels and are by no means exhaustive. Although m=4 and there are fifteen rows of pixels in the following examples, any number of rows may be present and m may equal any integer greater or equal to zero.

In the examples of FIGS. 9-14, B₀ will be used to collectively represent update data defining the states of all the pixels in a particular row of pixels during one time slice in a frame. B₁ will be used to collectively represent update data defining the states of all the pixels in a particular row of pixels during two time slices in a frame. B₂ will be used to collectively represent update data defining the states of all the pixels in a particular row of pixels during four time slices in a frame. Finally, B₃ will be used to collectively represent update data defining the states of all the pixels in a particular row of pixels during eight time slices in a frame.

FIG. 9 illustrates an exemplary update scheme for a number of rows of pixels. The update scheme shown in FIG. 9 generates sixteen gray scale levels for fifteen rows of pixels. Hence, m=4 in the example described in connection with FIG. 9. As shown in FIG. 9, each row is updated using a bit grouping method. Therefore, each row is updated four times during the frame. For example, as shown in FIG. 9, the first row may be updated during time slices 1, 2, 4, and 8. In other words, B₀ is sent during time slice 1, B₁ is sent during time slice 2, B₂ is sent during time slice 4, and B₃ is sent during time slice 8.

As shown in FIG. 9, the particular bit grouping method varies row by row. For example, the second row may be updated such that B₀, B₁, B₂, and B₃ are sent during time slices 2, 3, 5, and 9, respectively. The third row may be updated such that B₀, B₁, B₂, and B₃ are sent during time slices 3, 4, 6, and 10, respectively. FIG. 9 shows the update schemes for the remaining twelve rows.

As shown in FIG. 9, approximately m/2^{m} of the total number of rows of pixels are updated in each time slice. Thus, as shown in FIG. 9, update data for four of the fifteen rows of pixel is sent during each time slice. For example, rows 1, 9, 13, and 15 are updated in time slice 1. As will be explained below, updating four of the fifteen rows of pixels during each time slice results in a much lower peak update data rate as compared to a system wherein each row is updated during each time slice.

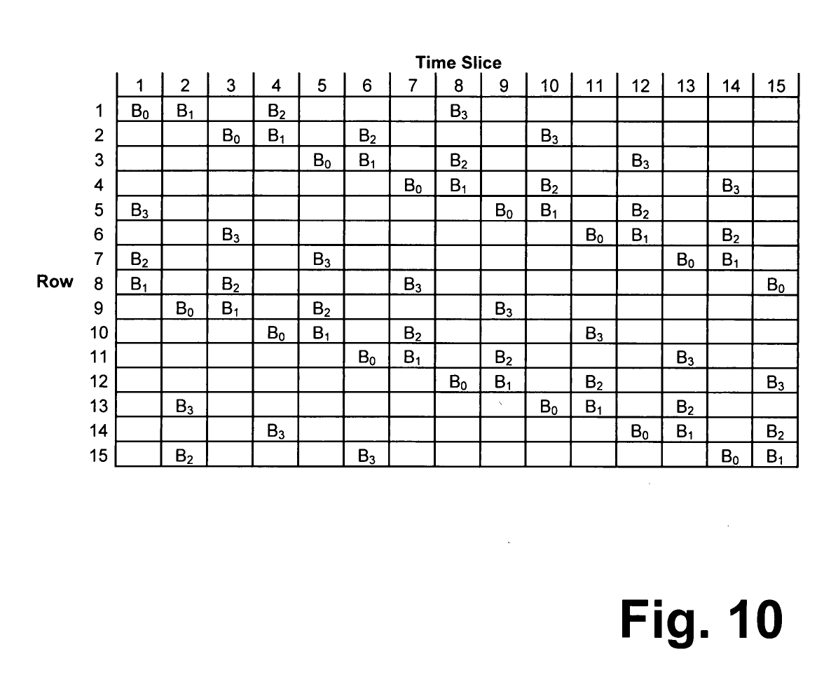

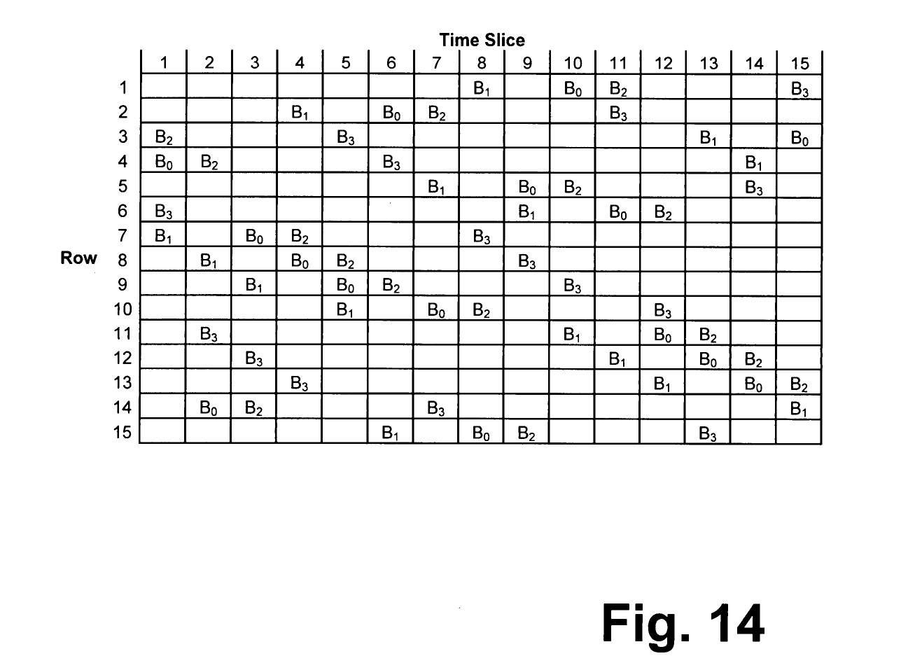

FIGS. 10-14 illustrate additional exemplary update schemes for a number of rows of pixels. In each of the examples of FIGS. 10-14, sixteen gray scale levels are generated for fifteen rows of pixels. Hence, m=4 in the examples described in connection with FIGS. 10-14. In each of the examples described in FIGS. 10-14, each row of pixels is updated using a bit grouping method. Therefore, each row is updated four times during the frame. The particular update scheme that is used to generate 2^{m} gray scale levels will vary as best serves a particular application. Furthermore, FIG. 14 illustrates that B₀, B₁, B₂, and B₃ may be sent to the modulator in any order. For example, the first row in FIG. 14 shows that B₁, B₀, B₂, and B₃ are sent in time slices 8, 10, 11, and 15, respectively.

An explanation of how the method described in connection with FIG. 8 decreases the peak update data rate as compared with traditional methods of generating 2^{m} gray scale levels will now be given. The peak update data rate, as previously explained, is the maximum update data rate that a display system must be capable of producing to generate 2^{m} gray scale levels. The average update data rate, on the other hand, is equal to the average amount of update data that is sent per time slice. As used in the following explanations and in the appended claims, unless otherwise specifically denoted, the variable “n” will be used to represent the total number of rows of pixels that are to be updated.

Table 1 shows a comparison of the peak update data rates and average update data rates associated with the method described in connection with FIG. 8 and with two traditional methods of generating 2^{m} gray scale levels for a number of rows of pixels. The first traditional method (constant update method) is a method wherein each row of pixels is updated during each time slice of a frame. The second traditional method (simultaneous bit grouping method) is a bit grouping method wherein each row is updated during the same time slices in a frame. Hence, although each row of pixels is updated during only m time slices in a frame using the simultaneous bit grouping method, the rows are all updated simultaneously. The method described in connection with FIG. 8 will be referred to as the “Evenly Distributed Bit Grouping Method” in Table 1 for explanatory purposes. All update data rates shown in Table 1 are in terms of number of rows updated per time slice. An explanation and comparison of the different peak and average update data rates will be given below.

TABLE 1
Comparison of Peak and Average Update Data Rates (rows
up datedltime slice)

| | Constant | | Evenly Distributed |
|---|---|---|---|
| | Update | Simultaneous Bit | Bit Grouping |
| | Method | Grouping Method | Method |
| Peak Update Data Rate | n | n | $\frac{m \cdot n}{{2}^{m}}$ |
| Average Update Data Rate | n | $\frac{m \cdot n}{{2}^{m}}$ | $\frac{m \cdot n}{{2}^{m}}$ |

As shown in Table 1, all n rows of pixels are updated during every time slice using the traditional constant update method. Thus, the average and peak update data rates are both equal to n for the constant update method. The simultaneous bit grouping method reduces the average update data rate by a factor of 2^{m}/m. However, because all n rows are updated at the same time, the simultaneous bit grouping method does not reduce the peak update data rate, which as shown in Table 1, is equal to n. The peak data rate for the simultaneous bit grouping method occurs when B₀ is sent to the SLM, requiring that all n rows be updated during a single time slice.

Table 1 shows that the exemplary method explained in connection with FIG. 8 reduces the traditional peak update data rate from n to m*n/2^{m}. In other words, the traditional peak data rate is reduced by a factor of 2^{m}/m. As shown in Table 1, the evenly distributed bit grouping method's peak and average update data rates are approximately equal. The reduction in the peak data rate is due to the fact that the bit updates are evenly distributed throughout the frame. Thus, for each time slice, only the data for a fraction of the rows approximately equal to m/2^{m} must be transmitted to the SLM.

In one embodiment, the row select logic (121; FIG. 2) is configured to implement the method described in connection with FIG. 8. In other words, the row select logic (121; FIG. 2) is configured to select a subset of the rows to be updated during each time slice. The row select logic may be any circuitry or device configured to select a subset of the rows to be updated during each time slice according to one exemplary embodiment.

In an alternative embodiment, the information about which rows should be updated in any given time slices is generated using a state machine integrated into the SLM (103; FIG. 2). In other words, the SLM (103; FIG. 2) is configured to implement the method described in connection with FIG. 8 without the aid of the row select logic (121; FIG. 2).

The preceding description has been presented only to illustrate and describe embodiments of invention. It is not intended to be exhaustive or to limit the invention to any precise form disclosed. Many modifications and variations are possible in light of the above teaching. It is intended that the scope of the invention be defined by the following claims.

1. A method of generating 2^{m} gray scale levels for a number of rows of pixels to be displayed during a video frame, said method comprising:
dividing said frame into 2^{m}-1 time slices;
updating each of said rows of pixels during m time slices; and
distributing said row updates among said time slices such that a substantially equal number of said rows of pixels are updated during each of said time slices;
wherein m is an integer greater than zero.

2. The method of claim 1, wherein said step of updating each of said rows of pixels comprises sending update data for each of said pixels in said rows to corresponding elements of a modulator during said m time slices.

3. The method of claim 2, wherein, for each row of said rows of pixels, said update data comprises m different update data sets, said update data sets each being sent to said modulator during one of said m time slices and defining a state of pixels in said row of pixels during 2^{x} time slices of said frame, wherein x comprises all integers between zero and m-1 and each value of x uniquely corresponds to one of said update data sets.

4. The method of claim 3, wherein said step of distributing said row updates comprises varying the order in which said m update data sets are sent to said modulator for each of said rows of pixels.

5. The method of claim 1, wherein said step of distributing said row updates comprises updating a number of rows of pixels substantially equal to m*n/2^{m} during each of said time slices, wherein n is an integer representing said number of rows displayed during said frame.

6. A system for generating 2^{m} gray scale levels for a number of rows of pixels to be displayed during a video frame, said system comprising a modulator having a number of rows of elements corresponding to said rows of pixels, wherein said modulator is configured to:
divide said frame into 2^{m}-1 time slices;
update each of said rows of pixels during m time slices; and
distribute said row updates among said time slices such that a substantially equal number of said rows of pixels are updated during each of said time slices;
wherein m is an integer greater than or equal to zero.

7. The system of claim 6, wherein said modulator is further configured to update each of said rows of pixels by controlling corresponding rows of elements during said m time slices in accordance with update data for each of said rows of pixels.

8. The system of claim 7, wherein said modulator is further configured to control said rows of elements by physically adjusting a position of said elements.

9. The system of claim 7, wherein, for each row of said rows of pixels, said update data comprises m different update data sets, said update data sets each being used by said modulator during one of said m time slices to control a corresponding row of elements and defining a state of pixels in said row of pixels during 2^{x} time slices of said frame, wherein x comprises all integers between zero and m-1 and each value of x uniquely corresponds to one of said update data sets.

10. The system of claim 9, wherein said modulator is further configured to vary the order in which said m update data sets are used to control each of said rows of elements.

11. The system of claim 6, wherein said modulator is further configured to control a number of rows of elements substantially equal to m*n/2^{m} during each of said time slices, wherein n is an integer representing said number of rows displayed during said frame.

12. The system of claim 6, wherein said elements comprise micromirrors.

13. The system of claim 6, wherein said modulator comprises a liquid crystal on silicon (LCOS) array.

14. The system of claim 6, wherein said modulator comprises a diffractive light device (DLD).

15. A system for generating 2^{m} gray scale levels for a number of rows of pixels to be displayed during a video frame divided into 2^{m}-1 time slices, said system comprising:
a modulator having a number of rows of elements corresponding to said rows of pixels and configured to update each of said rows of pixels during m time slices by controlling said rows of elements; and
row select logic configured to select which rows of pixels are to be updated during each of said time slices;
wherein said row select logic is configured to select said rows of pixels to be updated such that a substantially equal number of said rows of pixels are updated during each of said time slices and wherein m is an integer greater than or equal to zero.

16. The system of claim 15, wherein said row select logic is configured to send update data for each of said pixels in said rows of pixels to said modulator during said m time slices.

17. The system of claim 16, wherein, for each row of said rows of pixels, said update data comprises m different update data sets, said update data sets each being sent to said modulator during one of said m time slices and defining a state of pixels in said row of pixels during 2^{x} time slices of said frame, wherein x comprises all integers between zero and m-1 and each value of x uniquely corresponds to one of said update data sets.

18. The system of claim 17, wherein said modulator is further configured to vary the order in which said m update data sets are used to control each of said rows of elements.

19. The system of claim 15, wherein said modulator controls said rows of elements by physically adjusting a position of said corresponding rows of elements.

20. The system of claim 15, wherein said modulator is configured to control a number of rows of elements substantially equal to m*n/2^{m} during each of said time slices, wherein n is an integer representing said number of rows displayed during said frame.

21. The system of claim 15, wherein said elements comprise micromirrors.

22. The system of claim 15, wherein said modulator comprises a liquid crystal on silicon (LCOS) array.

23. The system of claim 15, wherein said modulator comprises a diffractive light device (DLD).

24. A system for generating 2^{m} gray scale levels for a number of rows of pixels to be displayed during a video frame, said system comprising:
means for dividing said frame into 2^{m}-1 time slices;
means for updating each of said rows of pixels during m time slices; and
means for distributing said row updates among said time slices such that a substantially equal number of said rows of pixels are updated during each of said time slices;
wherein m is an integer greater than or equal to zero.

25. The system of claim 24, wherein said means for updating each of said rows of pixels comprises means for sending update data for each of said pixels in said rows to corresponding elements of a modulator during said m time slices.

26. The system of claim 25, wherein, for each row of said rows of pixels, said update data comprises m different update data sets, said update data sets each being sent to said modulator during one of said m time slices and defining a state of pixels in said row of pixels during 2^{x} time slices of said frame, wherein x comprises all integers between zero and m-1 and each value of x uniquely corresponds to one of said update data sets.

27. The system of claim 26, wherein said means for distributing said row updates comprises varying the order in which said m update data sets are sent to said modulator for each of said rows of pixels.

28. The system of claim 24, wherein said means for distributing said row updates comprises means for updating a number of rows of pixels substantially equal to m*n/2^{m} during each of said time slices, wherein n is an integer representing said number of rows displayed during said frame.
